(19) United States
(12) Patent Application Publication
(10) Pub. No.: US 2022/0101350 A1
(43) Pub. Date: Mar. 31, 2022

(54) INFORMATION PUSHING METHOD AND APPARATUS

(71) Applicant: JINGDONG TECHNOLOGY HOLDING CO.,LTD., Beijing (CN)

(72) Inventor: Ying WANG, Beijing (CN)

(21) Appl. No.: 17/550,499

(22) Filed: Dec. 14, 2021

Related U.S. Application Data
(63) Continuation of application No. PCT/CN2020/076995, filed on Feb. 27, 2020.

(30) Foreign Application Priority Data
Jun. 26, 2019 (CN) 201910559744.X

(51) Int. Cl. G06Q 30/02; G06F 16/903

(52) U.S. Cl. CPC G06Q 30/0201; G06F 16/90335

(57) ABSTRACT

An information pushing method and apparatus, the method includes: acquiring and recording (101), a coordinate point of a location where a user terminal is located reported by the user terminal, and time when the coordinate point is reported; determining (102) a coordinate point which satisfies a preset condition of each user within a first preset time; dividing (103) a minimum rectangular area containing all coordinate points which satisfy the preset condition into a grid with a preset step length as a unit, and establishing a mapping relationship between a coordinate point in each grid and a corresponding grid; searching for (104) a corresponding neighborhood with a grid having a corresponding relationship with a coordinate point as a target; mapping (105) a grid in each cluster to a coordinate point in a corresponding grid according to the mapping relationship; and pushing (106) information at a corresponding location for any cluster.

### CROSS-REFERENCE TO RELATED APPLICATIONS

This application is a continuation of International Application No. PCT/CN2020/076995, filed on Feb. 27, 2020, which claims priority to the Chinese Patent Application No. 201910559744.X, filed to the China National Intellectual Property Administration on Jun. 26, 2019 and entitled “INFORMATION PUSHING METHOD AND APPARATUS”. The contents of the above applications are hereby incorporated by reference in their entireties in this application.

### TECHNICAL FIELD

The present application relates to the field of computer processing technology, in particular, to an information pushing method and apparatus.

### BACKGROUND

Location-based service (geomarketing) is a new type of discipline that has emerged along with rapid development and wide application of geographic information systems (GIS), and is a powerful tool for industry-assisted decision-making and geographic market analysis. The location-based service is closely related to marketing, but the location-based service focuses on analyzing an impact of space and distance on marketing and economic activities.

The location-based service field is wide and colorful, and cooperation with traditional businesses provides unlimited space for its future development.

A premise of location-based service is that users in different geographic locations need to be aggregated, and then accurate information is pushed according to specific preferences and portraits (user's attribute information) of users in similar locations.

According to coordinate data reported by a buried point of a mobile app browsing log, a location point where a user often stays can be obtained. However, spatial data has certain requirements for clustering algorithms due to its specificity: it should be able to find clusters of any shape; the number of clusters is impossible to be determined a priori, so division-based clustering (K_means, etc.) is basically not feasible; it should be insensitive to noise data.

A density-based clustering algorithm such as a density-based spatial clustering of applications with noise (DBSCAN) algorithm is a relatively classic spatial clustering algorithm that can aggregate into an arbitrarily shaped cluster in spatial data containing noise.

### SUMMARY

The present application provides an information pushing method and apparatus.

In an embodiment, an information pushing method is provided, including:

acquiring and recording a coordinate point of a location where a user terminal is located reported by the user terminal, and time when the coordinate point is reported;

determining a coordinate point which satisfies a preset condition of each user within a first preset time;

dividing a minimum rectangular area containing all coordinate points which satisfy the preset condition into a grid with a preset step length as a unit, and establishing a mapping relationship between a coordinate point in each grid and a corresponding grid;

searching for a corresponding neighborhood through an eight-direction neighborhood mode with a grid having a corresponding relationship with a coordinate point as a target, in a clustering process using a density-based spatial clustering of applications with noise algorithm based on grid search;

mapping a grid in each cluster after clustering to a coordinate point in a corresponding grid according to the mapping relationship; and

pushing information at a corresponding location according to a portrait of a user corresponding to a coordinate point within a cluster for any cluster.

In another embodiment, an information pushing apparatus is provided, including: an acquiring unit, a determining unit, an establishing unit, a clustering unit, a mapping unit and a pushing unit;

the acquiring unit is configured to acquire and record a coordinate point of a location where a user terminal is located reported by the user terminal, and time when the coordinate point is reported;

the determining unit is configured to determine a coordinate point recorded by the acquiring unit which satisfies a preset condition of each user within a first preset time;

the establishing unit is configured to divide a minimum rectangular area containing all coordinate points which satisfy the preset condition determined by the determining unit into a grid with a preset step length as a unit, and establish a mapping relationship between a coordinate point in each grid and a corresponding grid;

the clustering unit is configured to search for a corresponding neighborhood through an eight-direction neighborhood mode with a grid divided by the establishing unit having a corresponding relationship with a coordinate point as a target in a clustering process using a density-based spatial clustering of applications with noise algorithm based on grid search;

the mapping unit is configured to map a grid in each cluster clustered by the clustering unit to a coordinate point in a corresponding grid according to the mapping relationship established by the establishing unit; and

the pushing unit is configured to push information at a corresponding location according to a portrait of a user corresponding to a coordinate point within a cluster mapped by the mapping unit for any cluster.

In another embodiment, an electronic device is provided, including a memory, a processor, and a computer program stored in the memory and run on the processor, where the processor, when executing the program, implements the steps of the information pushing method.

In another embodiment, a computer-readable storage medium is provided with a computer program stored thereon, where the program, when executed by a processor, implements the steps of the information pushing method.

In another embodiment, a chip for executing instructions is provided, where the chip includes a memory and a processor, the memory stores code and data, the memory is coupled with the processor, and the processor runs the code in the memory, to enable the chip to be used to execute the steps of the above-mentioned information pushing method.

In another embodiment, a program product containing instructions is provided, where the program product, when run on a computer, enables the computer to execute the steps of the above-mentioned information pushing method.

In another embodiment, a computer program is provided, where the computer program, when executed by a processor, is used to execute the steps of the above-mentioned information pushing method.

### BRIEF DESCRIPTION OF DRAWINGS

The following accompanying drawings are only a schematic description and explanation of the present application, but not to limit the scope of the present application:

FIG. 1 is a schematic flowchart of an information pushing process in an embodiment of the present application;

FIG. 2 is a schematic flowchart of a clustering process using a DBSCAN algorithm based on grid search in an embodiment of the present application;

FIG. 3 is a schematic diagram of a first-order neighborhood of a search point P;

FIG. 4 is a schematic diagram of a second-order neighborhood of the search point P; and

FIG. 5 is a schematic structural diagram of an apparatus based on the above-mentioned technology in an embodiment of the present application.

### DESCRIPTION OF EMBODIMENTS

In order to make the purpose, technical solutions and advantages of the embodiments of the present application clearer, the technical solutions of the present application will be described in detail with reference to the accompanying drawings and embodiments.

The existing DBSCAN algorithm applied to mobile buried coordinate data has the following problems:

when a spatial area is large or data volume is large, the efficiency of the DBSCAN algorithm is very poor.

An embodiment of the present application provides an information pushing method, which is applied to a system including a user terminal, a server and a pushing terminal.

The user terminal is configured to report a coordinate point of a location where the terminal is located, and provide some network access information, shopping information, etc., to determine a user portrait.

The user portrait is a labeled user model abstracted from information such as a social attribute, a living habit and a consumption behavior of a user.

The server is configured to cluster according to location information (a coordinate point) reported by the user terminal, determine which coordinate points correspond to users belonging to a cluster, and then push information according to a user portrait of the user corresponding to the coordinate points in the cluster, where the pushed information can be an electronic advertisement, and relevant information can be pushed in place such as an elevator, a public restroom, a community gate, etc.

The pushing terminal is configured to display information pushed by the server.

Among the above-mentioned three devices, the present application mainly improves information acquisition on the user terminal and the clustering process on the server. The present application does not limit which kind of information pushing is performed based on the user portrait.

An information pushing process by the server in the present application embodiment is described in detail in combination with the accompanying drawings.

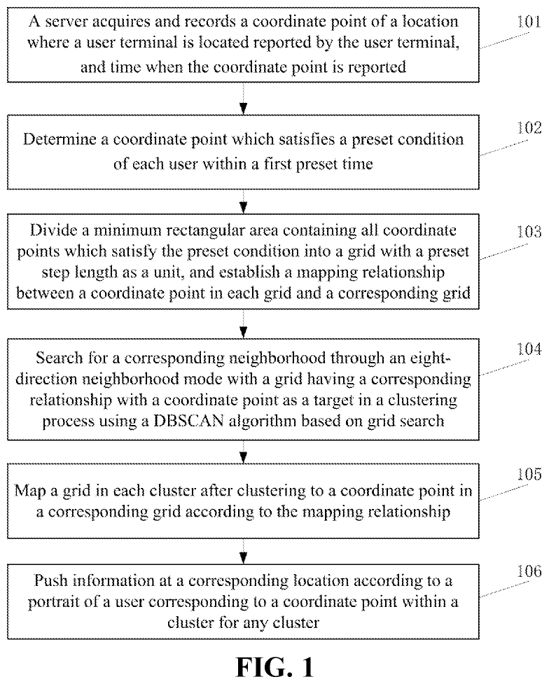

Referring to FIG. 1, FIG. 1 a schematic flowchart of an information pushing process in an embodiment of the present application. The specific steps are:

step 101: a server acquires and records a coordinate point of a location where a user terminal is located reported by the user terminal, and time when the coordinate point is reported.

When a user browses an app, every time a page is updated, a coordinate point of a location where the user is located at that time will be reported.

The server receives the coordinate point of the location reported by the user terminal every time the page is updated, and records the reported coordinate point and the time when the coordinate point is acquired.

Referring to Table 1. Table 1 shows a corresponding relationship between each coordinate point of user 1 and time.

TABLE 1

| Longitude | Latitude | Acquisition time |
|---|---|---|
| lon1 | lat1 | 00:00 |
| lon1 | lat1 | 00:10 |
| lon1 | lat1 | 00:30 |
| lon2 | lat2 | 00:35 |
| lon2 | lat2 | 00:40 |
| lon3 | lat3 | 00:45 |

The coordinate points in Table 1 are identified by longitude and latitude information.

Step 102: determine a coordinate point which satisfies a preset condition of each user within a first preset time.

In the embodiment of the present application, for validity of subsequently processed data, it is also necessary to determine validity of data recorded for each user within the first preset time first, and the specific processing is as follows:

determine whether the number of recorded coordinate points is greater than a preset number threshold within the first preset time, if yes, consider the user as an active user, and perform the operation of step 102 for the user; otherwise, consider the user as an inactive user, and delete the coordinate point and time corresponding to the user.

In the present step, the determining a coordinate point which satisfies a preset condition of each user within a first preset time includes:

step 1: count a duration that each user stays at each coordinate point within the first preset time.

Taking the contents shown in Table 1 as a premise, the process of determining the stay duration at each coordinate point is implemented by a specific example as follows.

Continuous time points recorded in Table 1 for a coordinate point (lon1, lat1) are 00:00, 00:10, and 00:30, then it is determined that the time that user 1 stays at the coordinate point (lon1, lat1) is 30 minutes.

Based on the above-mentioned method of determining the stay time of the user 1 at each coordinate point, the duration that the user 1 stays at each coordinate point is determined. See Table 2 for details, Table 2 is content corresponding to the duration that the user 1 stays at each coordinate point obtained according to Table 1.

TABLE 2

| | | | | Time |
|---|---|---|---|---|
| Start time | End time | Longitude | Latitude | difference |
| 00:00 | 00:30 | lon1 | lat1 | 30 |
| 00:35 | 00:40 | lon2 | lat2 | 5 |
| 00:45 | 00:45 | lon3 | lat3 | 0 |

Step 2: select two coordinate points with longest stay time for each user.

As shown in Table 2, the selected coordinate points are a coordinate point (lon1, lat1) and a coordinate point (lon2, lat2).

Step 3: determine whether a difference ratio between stay times of the two coordinate points is less than a preset ratio value, if yes, determine both coordinate points with longest stay time as the coordinate point which satisfies the preset condition; otherwise, determine a coordinate point with longer stay time between the two coordinate points with longest stay time as the coordinate point which satisfies the preset condition.

In the embodiment of the present application, the difference ratio between the stay times of the two coordinate points is: a ratio of an absolute value of a difference between the stay times of the two coordinate points to a longest stay time.

As shown in Table 2, the stay time of the coordinate point (lon1, lat1) is 30 minutes, and the stay time of the coordinate point (lon2, lat2) is 5 minutes, then the difference ratio of the stay times is:

$$\frac{\vert 30 - 5 \vert}{30} \approx 83 \% ;$$

it is assumed that the preset ratio value is 30%, the difference ratio between the stay times of the two coordinate points is greater than the preset ratio threshold, which indicates that the difference of the stay times of the two coordinate points is relatively large, then only the coordinate point with the longest stay time (lon1, lat1) is retained.

If the difference ratio between the stay times of the two coordinate points is not greater than the preset ratio threshold, it indicates that the difference of the stay times of the two coordinate points is not large, and both the two coordinate points are relatively important, then the two coordinate points are retained.

Step 103: divide a minimum rectangular area containing all coordinate points which satisfy the preset condition into a grid with a preset step length as a unit, and establish a mapping relationship between a coordinate point in each grid and a corresponding grid.

After the determining a coordinate point which satisfies a preset condition of each user within a first preset time in step 102, before the dividing a minimum rectangular area containing all coordinate points which satisfy the preset condition into a grid with a preset step length as a unit in step 103, the method further includes: filter out a coordinate point in a low-density area, and specific implementation is as follows:

step 1: divide the minimum rectangular area containing all coordinate points which satisfy the preset condition into a grid with N times the preset step length as a unit; where N is an integer greater than 2;

where minimum rectangular areas of all coordinates to be processed can be determined by a range corresponding to minimum longitude and latitude and maximum latitude and longitude of the coordinate points; and

step 2: if it is determined that a number of coordinate points in any grid is less than a preset number threshold, then delete the coordinate points in the grid from all coordinate points which satisfy the preset condition.

The preset step length here is an actual step length when a grid is divided, and here the grid is firstly divided with more than twice the step length, so that each grid corresponds to a relatively large area, and if the number of coordinate points is still small in such a large area, the grid is considered to be a low-density area, then the coordinate points in the grid are filtered out.

The retained coordinate points will continue to be processed with step 103.

In the embodiment of the present application, an identification for the grid is defined in terms of longitude and latitude as a reference number respectively, such as 2-8 indicates that the grid is a grid in a second row in terms of longitude and an eighth row in terms of latitude.

In the embodiment of the present application, the establishing a mapping relationship between a coordinate point in each grid and a corresponding grid includes:

take an i-th coordinate point as an example;

establish a mapping relationship between a coordinate (lonᵢ, latᵢ) of the i-th coordinate point and a grid identifier (lon_idᵢ_lat_idᵢ) as:

calculate a difference between the lonᵢ and minlon, and take a value obtained by rounding up a quotient of the difference with w as the lon_idᵢ;

which is

$${lon\_id}_{i} = [ \frac{{lon}_{i} - minlon}{w} ] ;$$

and

calculate a difference between the latᵢ and minlat, and take a value obtained by rounding up a quotient of the difference with w as the lat_idᵢ;

which is

$${lat\_id}_{i} = [ \frac{{lat}_{i} - minlat}{w} ] ;$$

where the minlon and the minlat are minimum longitude and latitude coordinates of the minimum rectangular area; and the w is the preset step length.

Through the above-mentioned algorithm, a mapping relationship between each coordinate point and a grid identifier can be determined. As shown in Table 3, Table 3 shows a mapping relationship between a coordinate point and a grid identifier.

TABLE 3

| Longitude | Latitude | user_id | lon_id | lat_id | grid_id |
|---|---|---|---|---|---|
| lon1 | lat1 | User1 | 2 | 8 | 2_8 |
| lon2 | lat2 | User2 | 2 | 8 | 2_8 |
| lon3 | lat3 | User3 | 14 | 28 | 14_28 |

In Table 3, the user_id is a user identifier, and the grid_id is a grid identifier. There can be one or more coordinate points in a grid.

Step 104: search for a corresponding neighborhood through an eight-direction neighborhood mode with a grid having a corresponding relationship with a coordinate point as a target in a clustering process using a DBSCAN algorithm based on grid search.

Through step 103, the target of clustering is converted from a coordinate point to a grid, and next, in the clustering process using the DBSCAN algorithm, a neighborhood search is performed with a grid having a mapping relationship with the coordinate point as a target, that is, a target with a corresponding coordinate point, a grid without a corresponding coordinate point will not be processed, instead of performing a neighborhood search with the coordinate point as a target.

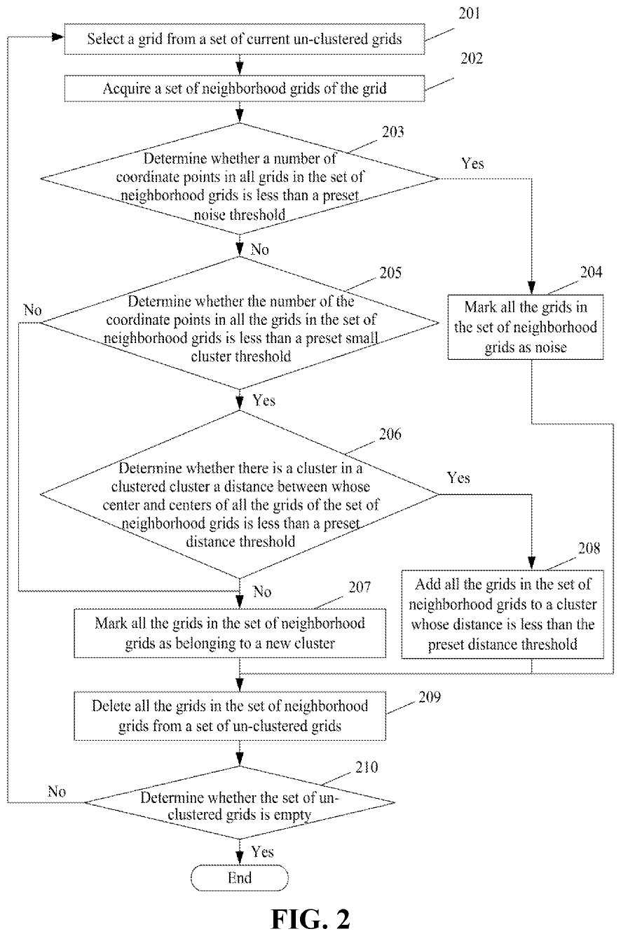

Referring to FIG. 2, FIG. 2 is a schematic flowchart of a clustering process using a DBSCAN algorithm based on grid search in an embodiment of the present application. The specific steps are:

step 201: select a grid from a set of current un-clustered grids.

Before performing clustering on grids, all the grids are un-clustered grids forming a set of un-clustered grids.

Here, the grids forming the set of un-clustered grids are grids having a mapping relationship with the coordinate points.

Selecting a grid here can be a random selection, or selecting with a rule for selecting a grid being given according to an actual application, to reduce the number of searches, which is not limited in the embodiment of the present application.

Step 202: acquire a set of neighborhood grids of the grid.

The set includes the grid.

When acquiring a neighborhood set of the selected grid, a corresponding neighborhood is searched for through an eight-direction neighborhood mode with the grid as a target. The specific acquisition process is as follows:

step 1: for any grid P, take the grid P as a center grid, and search for an eight-direction neighborhood grid of the grid P.

When searching for the eight-direction neighborhood grid of the grid, the searched grid is a grid in the set of un-clustered grids; for a grid that is an eight-direction neighborhood grid of a grid, but not a grid in the set of current un-clustered grids, it is not treated as an eight-direction neighborhood grid of the grid.

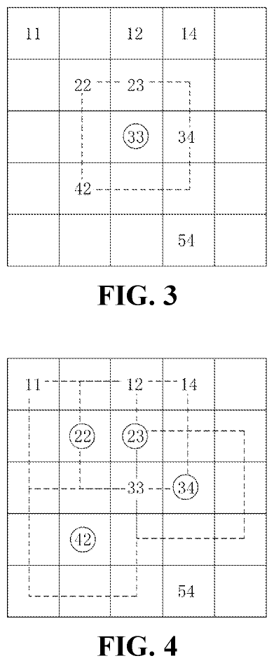

Referring to FIG. 3, FIG. 3 is a schematic diagram of a first-order neighborhood of a search point P. In FIG. 3, a search point P is taken as a grid 33 for example, a grid given with a grid identifier in FIG. 3 is a grid with a coordinate point, and in FIG. 3, eight-direction neighborhood grids of the grid 33 are a grid 22, a grid 23, a grid 34, and a grid 42, the other four grids are not neighborhood grids of the grid 33.

Step 2: search for an eight-direction neighborhood grid of each neighborhood grid with all found neighborhood grids as a center grid again.

For a first-order neighborhood grid found in the step 1, the searched first-order neighborhood grid is taken as a center grid for performing an eight-direction neighboring grid search again.

Referring to FIG. 4, FIG. 4 is a schematic diagram of a second-order neighborhood of the search point P.

The first-order neighborhood grids are the grid 22, the grid 23, the grid 34, and the grid 42, then eight-direction neighborhood grids for the grid 22 are a grid 11, a grid 13, the grid 23 and the grid 33, since the grid 23 and the grid 33 have been searched before, therefore, for the grid 22, the grid 11 and the grid 13 are taken as second-order neighborhood grids of the point P; similarly, it can be obtained that for the grid 23, a grid 14 is taken as a second-order neighboring grid of the point P; for the grid 34 and the grid 42, there is no new second-order grid for the point P; and

based on the above-mentioned search, all current neighboring grids of the point P are: the grid 33, the grid 22, the grid 23, the grid 34, the grid 42, the grid 11, the grid 13, and the grid 14.

Step 3: end search of neighborhood grids until a total distance of all the searched neighborhood grids is greater than a preset clustering diameter or there is no new neighborhood grid.

The total distance of all the neighborhood grids is a diagonal length of a minimum rectangular area corresponding to all the neighborhood grids.

Assuming it is determined that the diagonal length of the minimum rectangular area corresponding to all the current neighborhood grids (after the second-order search) is greater than the clustering diameter, or there is no new neighborhood grid which is searched with the second-order neighborhood grid as a center, the search for the point P is ended; otherwise, the search is continued in a similar manner.

All the searched neighboring grids and the grid P are taken as a set of neighborhood grids of the grid P.

Step 203: determine whether a number of coordinate points in all grids in the set of neighborhood grids is less than a preset noise threshold, if yes, perform step 204; otherwise, perform step 205.

Step 204: mark all the grids in the set of neighborhood grids as noise; perform step 209.

Step 205: determine whether the number of the coordinate points in all the grids in the set of neighborhood grids is less than a preset small cluster threshold, if yes, perform step 206; otherwise, perform step 207.

The preset small cluster threshold is greater than the preset noise threshold.

Step 206: determine whether there is a cluster in a clustered cluster a distance between whose center and centers of all the grids of the set of neighborhood grids is less than a preset distance threshold, if yes, perform step 208; otherwise, perform step 207.

A coordinate of a center point of a cluster is a mean value of coordinate points of all grids in the cluster, where the mean value of the coordinate points is calculated by longitude and latitude. if there are N coordinate points in a cluster, then a specific determination method of a center coordinate (Core_lon_{N}, Core_lat_{N}) of the cluster is as follows:

$${Core\_lon}_{N} = \frac{{\sum }_{1}^{N} {lon}_{i}}{N} ;$$

$${Core\_lat}_{N} = \frac{{\sum }_{1}^{N} {lat}_{i}}{N} ;$$

where the lonᵢ and latᵢ are longitude and latitude coordinates of an i-th coordinate point among the N coordinate points.

A center of all the grids in the set of neighboring grids is a mean value of coordinate points corresponding to all the grids, which is similar to the calculation method of the center of the cluster, and will not be described in detail here.

Step 207: mark all the grids in the set of neighborhood grids as belonging to a new cluster; perform step 209.

Step 208: add all the grids in the set of neighborhood grids to a cluster whose distance is less than the preset distance threshold.

Step 209: delete all the grids in the set of neighborhood grids from a set of un-clustered grids.

Step 210: determine whether the set of un-clustered grids is empty, if yes, end the process; otherwise, perform step 201.

So far, the clustering of all the grids is completed.

A clustering using the DBSCAN algorithm with a grid as a target can greatly improve computing efficiency, thereby greatly improving information pushing efficiency of a device.

Step 105: map a grid in each cluster after clustering to a coordinate point in a corresponding grid according to the mapping relationship.

The mapping relationship between coordinate points and grid identifiers is given in Table 3, and clustering of the coordinate points can be realized by mapping a clustered grid to a corresponding coordinate point.

Step 106: push information at a corresponding location according to a portrait of a user corresponding to a coordinate point within a cluster for any cluster.

When specifically implementing the embodiment of the present application, a coordinate point and a user also have a corresponding relationship, and information can be pushed at a location corresponding to a corresponding cluster according to a portrait of the user, and specific implementation of step 106 is not limited in the embodiment of the present application.

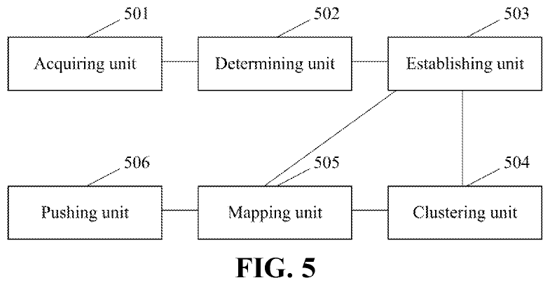

Based on the same inventive concept, the present application further provides an information pushing apparatus. Referring to FIG. 5, FIG. 5 is a schematic structural diagram of an apparatus based on the above-mentioned technology in an embodiment of the present application. The apparatus includes: an acquiring unit 501, a determining unit 502, an establishing unit 503, a clustering unit 504, a mapping unit 505 and a pushing unit 506;

the acquiring unit 501 is configured to acquire and record a coordinate point of a location where a user terminal is located reported by the user terminal, and time when the coordinate point is reported;

the determining unit 502 is configured to determine a coordinate point recorded by the acquiring unit 501 which satisfies a preset condition of each user within a first preset time;

the establishing unit 503 is configured to divide a minimum rectangular area containing all coordinate points which satisfy the preset condition determined by the determining unit 502 into a grid with a preset step length as a unit, and establish a mapping relationship between a coordinate point in each grid and a corresponding grid;

the clustering unit 504 is configured to search for a corresponding neighborhood through an eight-direction neighborhood mode with a grid divided by the establishing unit 503 having a corresponding relationship with a coordinate point as a target, in a clustering process using a density-based spatial clustering of applications with noise algorithm based on grid search;

the mapping unit 505 is configured to map a grid in each cluster clustered by the clustering unit 504 to a coordinate point in a corresponding grid according to the mapping relationship established by the establishing unit 503; and

the pushing unit 506 is configured to push information at a corresponding location according to a portrait of a user corresponding to a coordinate point within a cluster mapped by the mapping unit 505 for any cluster.

In an embodiment, the determining unit 502 is specifically configured to, when determining the coordinate point which satisfies the preset condition of each user within the first preset time, count a duration that each user stays at each coordinate point within the first preset time; select two coordinate points with longest stay time for each user; and determine whether a difference ratio between stay times of the two coordinate points is less than a preset ratio value, if yes, determine both coordinate points with longest stay time as the coordinate point which satisfies the preset condition; otherwise, determine a coordinate point with longer stay time between the two coordinate points with longest stay time as the coordinate point which satisfies the preset condition.

In an embodiment, the establishing unit 503 is further configured to, before dividing the minimum rectangular area containing all the coordinate points which satisfy the preset condition into the grid with the preset step length as a unit, divide the minimum rectangular area containing all coordinate points which satisfy the preset condition into a grid with N times the preset step length as a unit; wherein N is an integer greater than 2; and if it is determined that a number of coordinate points in any grid is less than a preset number threshold, then delete the coordinate points in the grid from all coordinate points which satisfy the preset condition.

In an embodiment, the establishing unit 503 is specifically configured to establish a mapping relationship between a coordinate (lonᵢ, latᵢ) of an i-th coordinate point and a grid identifier (lon_idᵢ_lat_idᵢ) as: calculate a difference between the lonᵢ and minlon, and take a value obtained by rounding up a quotient of the difference with w as the lon_idᵢ; and calculate a difference between the latᵢ and minlat, and take a value obtained by rounding up a quotient of the difference with w as the lat_idᵢ; wherein the minlon and the minlat are minimum longitude and latitude coordinates of the minimum rectangular area; and the w is the preset step length.

In an embodiment, the clustering unit 504 is specifically configured to, for any grid P, take the grid P as a center grid, and search for an eight-direction neighborhood grid of the grid P; search for an eight-direction neighborhood grid of each neighborhood grid with all searched neighborhood grids as a center grid again; end search of neighborhood grids until a total distance of all the searched neighborhood grids is greater than a preset clustering diameter or there is no new neighborhood grid; and take all the searched neighborhood grids and the grid P as a set of neighborhood grids of the grid P; wherein the total distance of all the neighborhood grids is a diagonal length of a minimum rectangular area corresponding to all the neighborhood grids.

In an embodiment, the clustering unit 504 is specifically configured to, in the clustering process using the density-based spatial clustering of applications with noise algorithm based on the grid search, select a grid from a set of current un-clustered grids; acquire a set of neighborhood grids of the grid; mark all grids in the set of neighborhood grids as noise when it is determined that a number of coordinate points in all the grids in the set of neighborhood grids is less than a preset noise threshold; add all the grids in the set of neighborhood grids to a cluster whose distance is less than a preset distance threshold when it is determined that the number of the coordinate points in all the grids in the set of neighborhood grids is less than a preset small cluster threshold and there is a cluster in a clustered cluster a distance between whose center and centers of all the grids of the set of neighborhood grids is less than the preset distance threshold; mark all the grids in the set of neighborhood grids as belonging to a new cluster when it is determined that the number of the coordinate points in all the grids in the set of neighborhood grids is less than the preset small cluster threshold and there is a cluster in the clustered cluster a distance between whose center and the centers of all the grids of the set of neighborhood grids is not less than the preset distance threshold, or the number of the coordinate points in all the grids in the set of neighborhood grids is not less than the preset noise threshold; delete all the grids in the set of neighborhood grids from a set of un-clustered grids; determine whether the set of un-clustered grids is empty, if yes, end the process; otherwise, perform a search on the set of current un-clustered grids; wherein, the preset noise threshold is less than the preset small cluster threshold.

The units of the above-mentioned embodiment can be integrated or deployed separately; they can be combined into one unit or be further split into multiple sub-units.

In another embodiment, an electronic device is provided, including a memory, a processor, and a computer program stored in the memory and run on the processor, where the processor, when executing the program, implements the steps of the information pushing method.

In another embodiment, an embodiment of the present application provides a computer-readable storage medium with a computer program stored thereon, where the program, when executed by a processor, implements the steps of the information pushing method.

In another embodiment, an embodiment of the present application provides a chip for executing instructions, where the chip includes a memory and a processor, the memory stores code and data, the memory is coupled with the processor, and the processor runs the code in the memory, to enable the chip to be used to execute the steps of the above-mentioned information pushing method.

In another embodiment, an embodiment of the present application provides a program product containing instructions, where the program product, when run on a computer, enables the computer to execute the steps of the above-mentioned information pushing method.

In another embodiment, an embodiment of the present application provides a computer program, where the computer program, when executed by a processor, is used to execute the steps of the above-mentioned information pushing method.

In summary, the present application, by converting a search neighborhood target from a coordinate point to a grid in the DBSCAN algorithm clustering, greatly accelerate clustering speed, thereby improving information pushing efficiency.

The above-mentioned is only a preferred embodiment of the present application and is not intended to limit the present application. Any modification, equivalent replacement, improvement, etc., made within the spirit and principle of the present application shall be included in the scope of protection of the present application.

What is claimed is:

1. An information pushing method, comprising:
acquiring and recording a coordinate point of a location where a user terminal is located reported by the user terminal, and time when the coordinate point is reported;
determining a coordinate point which satisfies a preset condition of each user within a first preset time;
dividing a minimum rectangular area containing all coordinate points which satisfy the preset condition into a grid with a preset step length as a unit, and establishing a mapping relationship between a coordinate point in each grid and a corresponding grid;
searching for a corresponding neighborhood through an eight-direction neighborhood mode with a grid having a corresponding relationship with a coordinate point as a target in a clustering process using a density-based spatial clustering of applications with noise algorithm based on grid search;
mapping a grid in each cluster after clustering to a coordinate point in a corresponding grid according to the mapping relationship; and
pushing information at a corresponding location according to a portrait of a user corresponding to a coordinate point within a cluster for any cluster.

2. The method according to claim 1, wherein the determining a coordinate point which satisfies a preset condition of each user within a first preset time comprises:
counting a duration that each user stays at each coordinate point within the first preset time;
selecting two coordinate points with longest stay time for each user; and
determining whether a difference ratio between stay times of the two coordinate points is less than a preset ratio value, if yes, determining both coordinate points with longest stay time as the coordinate point which satisfies the preset condition; otherwise, determining a coordinate point with longer stay time between the two coordinate points with longest stay time as the coordinate point which satisfies the preset condition.

3. The method according to claim 1, wherein after the determining a coordinate point which satisfies a preset condition of each user within a first preset time, and before the dividing a minimum rectangular area containing all coordinate points which satisfy the preset condition into a grid with a preset step length as a unit, the method further comprises:
dividing the minimum rectangular area containing all coordinate points which satisfy the preset condition into a grid with N times the preset step length as a unit; wherein N is an integer greater than 2; and
in a condition that it is determined that a number of coordinate points in any grid is less than a preset number threshold, then deleting the coordinate points in the grid from all coordinate points which satisfy the preset condition.

4. The method according to claim 2, wherein after the determining a coordinate point which satisfies a preset condition of each user within a first preset time, and before the dividing a minimum rectangular area containing all coordinate points which satisfy the preset condition into a grid with a preset step length as a unit, the method further comprises:
dividing the minimum rectangular area containing all coordinate points which satisfy the preset condition into a grid with N times the preset step length as a unit; wherein N is an integer greater than 2; and
in a condition that it is determined that a number of coordinate points in any grid is less than a preset number threshold, then deleting the coordinate points in the grid from all coordinate points which satisfy the preset condition.

5. The method according to claim 1, wherein the establishing a mapping relationship between a coordinate point in each grid and a corresponding grid comprises:
establishing a mapping relationship between a coordinate (lonᵢ, latᵢ) of an i-th coordinate point and a grid identifier (lon_idᵢ_lat_idᵢ) as:
calculating a difference between the lonᵢ and minlon, and taking a value obtained by rounding up a quotient of the difference with w as the lon_idᵢ; and
calculating a difference between the latᵢ and minlat, and taking a value obtained by rounding up a quotient of the difference with w as the lat_idᵢ;
wherein the minlon and the minlat are minimum longitude and latitude coordinates of the minimum rectangular area; and the w is the preset step length.

6. The method according to claim 2, wherein the establishing a mapping relationship between a coordinate point in each grid and a corresponding grid comprises:
establishing a mapping relationship between a coordinate (lonᵢ, latᵢ) of an i-th coordinate point and a grid identifier (lon_idᵢ_lat_idᵢ) as:
calculating a difference between the lonᵢ and minlon, and taking a value obtained by rounding up a quotient of the difference with w as the lon_idᵢ; and
calculating a difference between the latᵢ and minlat, and taking a value obtained by rounding up a quotient of the difference with w as the lat_idᵢ;
wherein the minlon and the minlat are minimum longitude and latitude coordinates of the minimum rectangular area; and the w is the preset step length.

7. The method according to claim 3, wherein the establishing a mapping relationship between a coordinate point in each grid and a corresponding grid comprises:
establishing a mapping relationship between a coordinate (lonᵢ, latᵢ) of an i-th coordinate point and a grid identifier (lon_idᵢ_lat_idᵢ) as:
calculating a difference between the lonᵢ and minlon, and taking a value obtained by rounding up a quotient of the difference with w as the lon_idᵢ; and
calculating a difference between the latᵢ and minlat, and taking a value obtained by rounding up a quotient of the difference with w as the lat_idᵢ;
wherein the minlon and the minlat are minimum longitude and latitude coordinates of the minimum rectangular area; and the w is the preset step length.

8. The method according to claim 4, wherein the establishing a mapping relationship between a coordinate point in each grid and a corresponding grid comprises:
establishing a mapping relationship between a coordinate (lonᵢ, latᵢ) of an i-th coordinate point and a grid identifier (lon_idᵢ_lat_idᵢ) as:
calculating a difference between the lonᵢ and minlon, and taking a value obtained by rounding up a quotient of the difference with w as the lon_idᵢ; and
calculating a difference between the latᵢ and minlat, and taking a value obtained by rounding up a quotient of the difference with w as the lat_idᵢ;
wherein the minlon and the minlat are minimum longitude and latitude coordinates of the minimum rectangular area; and the w is the preset step length.

9. The method according to claim 1, wherein the searching for a corresponding neighborhood through an eight-direction neighborhood mode with a grid having a corresponding relationship with a coordinate point as a target comprises:
for any grid P, taking the grid P as a center grid, and searching for an eight-direction neighborhood grid of the grid P;
searching for an eight-direction neighborhood grid of each neighborhood grid with all searched neighborhood grids as a center grid again;
ending search of neighborhood grids until a total distance of all the searched neighborhood grids is greater than a preset clustering diameter or there is no new neighborhood grid; and
taking all the searched neighborhood grids and the grid P as a set of neighborhood grids of the grid P;
wherein the total distance of all the neighborhood grids is a diagonal length of a minimum rectangular area corresponding to all the neighborhood grids.

10. The method according to claim 9, wherein the clustering process using a density-based spatial clustering of applications with noise algorithm based on grid search comprises steps of:
A, selecting a grid from a set of current un-clustered grids;
B, acquiring a set of neighborhood grids of the grid;
C, determining whether a number of coordinate points in all grids in the set of neighborhood grids is less than a preset noise threshold, in a condition that the number of coordinate points in all the grids in the set of neighborhood grids is less than the preset noise threshold, performing step D; otherwise, performing step E;
D, marking all the grids in the set of neighborhood grids as noise; performing step J;
E, determining whether the number of the coordinate points in all the grids in the set of neighborhood grids is less than a preset small cluster threshold, in a condition that the number of the coordinate points in all the grids in the set of neighborhood grids is less than the preset small cluster threshold, performing step F; otherwise, performing step G; wherein, the preset noise threshold is less than the preset small cluster threshold;
F, determining whether there is a cluster in a clustered cluster a distance between whose center and centers of all the grids of the set of neighborhood grids is less than a preset distance threshold, in a condition that there is the cluster in the clustered cluster the distance between whose center and centers of all the grids of the set of neighborhood grids is less than the preset distance threshold, performing step H; otherwise, performing step G;
G, marking all the grids in the set of neighborhood grids as belonging to a new cluster; performing step J;
H, adding all the grids in the set of neighborhood grids to a cluster whose distance is less than the preset distance threshold;
J, deleting all the grids in the set of neighborhood grids from a set of un-clustered grids; and
K, determining whether the set of un-clustered grids is empty, in a condition that the set of un-clustered grids is empty, ending the process; otherwise, performing step A.

11. An information pushing apparatus, comprising:
a processor,
a memory, and
a computer program;
wherein the computer program is stored in the memory and is configured to be executed by the processor, and the computer program comprises instructions to enable the processor to:
acquire and record a coordinate point of a location where a user terminal is located reported by the user terminal, and time when the coordinate point is reported;
determine a coordinate point recorded by the acquiring unit which satisfies a preset condition of each user within a first preset time;
divide a minimum rectangular area containing all coordinate points which satisfy the preset condition determined by the determining unit into a grid with a preset step length as a unit, and establish a mapping relationship between a coordinate point in each grid and a corresponding grid;
search for a corresponding neighborhood through an eight-direction neighborhood mode with a grid divided by the establishing unit having a corresponding relationship with a coordinate point as a target in a clustering process using a density-based spatial clustering of applications with noise algorithm based on grid search;
map a grid in each cluster clustered by the clustering unit to a coordinate point in a corresponding grid according to the mapping relationship established by the establishing unit; and
push information at a corresponding location according to a portrait of a user corresponding to a coordinate point within a cluster mapped by the mapping unit for any cluster.

12. The apparatus according to claim 11, wherein the processor is enabled to: when determining the coordinate point which satisfies the preset condition of each user within the first preset time, count a duration that each user stays at each coordinate point within the first preset time; select two coordinate points with longest stay time for each user; and determine whether a difference ratio between stay times of the two coordinate points is less than a preset ratio value, in a condition that the difference ratio between stay times of the two coordinate points is less than the preset ratio value, determine both coordinate points with longest stay time as the coordinate point which satisfies the preset condition; otherwise, determine a coordinate point with longer stay time between the two coordinate points with longest stay time as the coordinate point which satisfies the preset condition.

13. The apparatus according to claim 11, wherein the processor is enabled to: before dividing the minimum rectangular area containing all the coordinate points which satisfy the preset condition into the grid with the preset step length as a unit, divide the minimum rectangular area containing all coordinate points which satisfy the preset condition into a grid with N times the preset step length as a unit; wherein N is an integer greater than 2; and in a condition that it is determined that a number of coordinate points in any grid is less than a preset number threshold, then delete the coordinate points in the grid from all coordinate points which satisfy the preset condition.

14. The apparatus according to claim 12, wherein the processor is enabled to: before dividing the minimum rectangular area containing all the coordinate points which satisfy the preset condition into the grid with the preset step length as a unit, divide the minimum rectangular area containing all coordinate points which satisfy the preset condition into a grid with N times the preset step length as a unit; wherein N is an integer greater than 2; and in a condition that it is determined that a number of coordinate points in any grid is less than a preset number threshold, then delete the coordinate points in the grid from all coordinate points which satisfy the preset condition.

15. The apparatus according to claim 11, wherein the processor is enabled to:
establish a mapping relationship between a coordinate (lonᵢ, latᵢ) of an i-th coordinate point and a grid identifier (lon_idᵢ_lat_idᵢ) as: calculate a difference between the lonᵢ and minlon, and take a value obtained by rounding up a quotient of the difference with w as the lon_idᵢ; and calculate a difference between the latᵢ and minlat, and take a value obtained by rounding up a quotient of the difference with w as the lat_idᵢ; wherein the minlon and the minlat are minimum longitude and latitude coordinates of the minimum rectangular area; and the w is the preset step length.

16. The apparatus according to claim 12, wherein the processor is enabled to: establish a mapping relationship between a coordinate (lonᵢ, latᵢ) of an i-th coordinate point and a grid identifier (lon_idᵢ_lat_idᵢ) as: calculate a difference between the lonᵢ and minlon, and take a value obtained by rounding up a quotient of the difference with w as the lon_idᵢ; and calculate a difference between the latᵢ and minlat, and take a value obtained by rounding up a quotient of the difference with w as the lat_idᵢ; wherein the minion and the minlat are minimum longitude and latitude coordinates of the minimum rectangular area; and the w is the preset step length.

17. The apparatus according to claim 13, wherein the processor is enabled to: establish a mapping relationship between a coordinate (lonᵢ, latᵢ) of an i-th coordinate point and a grid identifier (lon_idᵢ_lat_idᵢ) as: calculate a difference between the lonᵢ and minion, and take a value obtained by rounding up a quotient of the difference with w as the ion_idᵢ; and calculate a difference between the latᵢ and minlat, and take a value obtained by rounding up a quotient of the difference with w as the lat_idᵢ; wherein the minion and the minlat are minimum longitude and latitude coordinates of the minimum rectangular area; and the w is the preset step length.

18. The apparatus according to claim 11, wherein the processor is enabled to: for any grid P, take the grid P as a center grid, and search for an eight-direction neighborhood grid of the grid P; search for an eight-direction neighborhood grid of each neighborhood grid with all searched neighborhood grids as a center grid again; end search of neighborhood grids until a total distance of all the searched neighborhood grids is greater than a preset clustering diameter or there is no new neighborhood grid; and take all the searched neighborhood grids and the grid P as a set of neighborhood grids of the grid P; wherein the total distance of all the neighborhood grids is a diagonal length of a minimum rectangular area corresponding to all the neighborhood grids.

19. The apparatus according to claim 18, wherein the processor is enabled to: in the clustering process using the density-based spatial clustering of applications with noise algorithm based on the grid search, select a grid from a set of current un-clustered grids; acquire a set of neighborhood grids of the grid; mark all grids in the set of neighborhood grids as noise when it is determined that a number of coordinate points in all the grids in the set of neighborhood grids is less than a preset noise threshold; add all the grids in the set of neighborhood grids to a cluster whose distance is less than a preset distance threshold when it is determined that the number of the coordinate points in all the grids in the set of neighborhood grids is less than a preset small cluster threshold and there is a cluster in a clustered cluster a distance between whose center and centers of all the grids of the set of neighborhood grids is less than the preset distance threshold; mark all the grids in the set of neighborhood grids as belonging to a new cluster when it is determined that the number of the coordinate points in all the grids in the set of neighborhood grids is less than the preset small cluster threshold and there is a cluster in the clustered cluster a distance between whose center and the centers of all the grids of the set of neighborhood grids is not less than the preset distance threshold, or the number of the coordinate points in all the grids in the set of neighborhood grids is not less than the preset noise threshold; delete all the grids in the set of neighborhood grids from a set of un-clustered grids; determine whether the set of un-clustered grids is empty, in a condition that the set of un-clustered grids is empty, end the process; otherwise, perform a search on the set of current un-clustered grids;
wherein, the preset noise threshold is less than the preset small cluster threshold.

20. A computer-readable storage medium with a computer program stored thereon, wherein the program, when executed by a processor, the following steps are implemented:
acquiring and recording a coordinate point of a location where a user terminal is located reported by the user terminal, and time when the coordinate point is reported;
determining a coordinate point which satisfies a preset condition of each user within a first preset time;
dividing a minimum rectangular area containing all coordinate points which satisfy the preset condition into a grid with a preset step length as a unit, and establishing a mapping relationship between a coordinate point in each grid and a corresponding grid;
searching for a corresponding neighborhood through an eight-direction neighborhood mode with a grid having a corresponding relationship with a coordinate point as a target in a clustering process using a density-based spatial clustering of applications with noise algorithm based on grid search;
mapping a grid in each cluster after clustering to a coordinate point in a corresponding grid according to the mapping relationship; and
pushing information at a corresponding location according to a portrait of a user corresponding to a coordinate point within a cluster for any cluster.
